(19) United States
(12) Patent Application Publication
(10) Pub. No.: US 2006/0148462 A1
(43) Pub. Date: Jul. 6, 2006

(54) Customizable mobile phone using at command

(76) Inventors: Xiongwei Zhu, Shanghai (CN); Hanjun Liu, Shanghai (CN); Xueli Lv, Shanghai (CN)

Correspondence Address: PERKINS COIE LLP;PATENT-SEA, P.O. BOX 1247, SEATTLE, WA, 98111-1247, US

(21) Appl. No.: 10/966,756

(22) Filed: Oct. 14, 2004

(51) Int. Cl. H04M 3/00

(52) U.S. Cl. 455/418

(57) ABSTRACT

A system and method is provided for downloading and uploading resource files, image files, and/or other files to and from a mobile phone using AT commands. An extended set of AT commands is defined for managing these files. The extended set of AT commands may then be used to directly download and upload files, or may be embodied in a software program for downloading and uploading files. The extended set of AT commands may also be used to manage and modify the resource files, image files, and other files, and to download, manage, and modify directories in the mobile phone.

### BACKGROUND

Mobile phones typically include resource files, such as ring tone and background “wallpaper” files, stored in memory segments of the phones. In many mobile phones, the resource files are stored in a nonvolatile memory, such as a flash memory, of the phones. In some phones, resource files resident in a phone's nonvolatile memory may be modified, or replaced by new files. The new resource files may be located in a database in the phone's memory, or they may be downloaded from the Internet or via a computer program. To facilitate downloading of resource files, many mobile phones are connectable to computers via cables and/or wireless connections.

Many mobile phones also include cameras for taking digital photographs, or digital pictures. The picture images can typically be uploaded to a computer by connecting the phone to the computer and loading the image data into a database of a photo management program, or other software program, resident in the computer. Many photo management programs include an interface allowing a user to modify the uploaded images. The uploaded images may typically be printed on photo paper, and/or sent to others via email or another communication system.

While existing systems and methods for downloading and uploading resource files and image files to and from mobile phones have been relatively effective, a need exists for alternative systems and methods to provide flexibility, and to meet the needs of a variety of users that utilize a variety of mobile phones and/or computing systems.

### SUMMARY OF THE INVENTION

The invention is directed to systems and methods for downloading and uploading resource files, image files, and/or other files to and from a mobile phone using AT (Attention) commands. An extended set of AT commands is defined for managing these files. The extended set of AT commands may be used to directly download and upload files, or may be embodied in a software program for downloading and uploading files. The extended set of AT commands may also preferably be used to manage and modify the resource files, image files, and other files, and to download, manage, and modify directories in the mobile phone.

In one aspect, a method for downloading a resource file to a phone includes defining a set of AT commands for managing resource files, and connecting the phone to a computer. A first resource file stored in the computer is read, via at least one of the AT commands. The first resource file is then downloaded, via at least one of the AT commands, into a nonvolatile memory of the phone.

In another aspect, the AT commands are executable via a software program in which the AT commands are embodied.

In another aspect, the phone is connected to the computer via a GSM terminal adapter.

In another aspect, a method for downloading or uploading files to or from a mobile phone includes defining a set of AT commands for managing the files, and connecting the phone to a computer. A resource file stored in the computer, or an image file stored in the phone, is read via at least one of the AT commands. The resource file or image file is then downloaded or uploaded, via at least one of the AT commands, into a nonvolatile memory of the phone or a memory segment of the computer, respectively.

In another aspect, the resource file or image file comprises a plurality of file blocks, and the downloading or uploading step is successively performed for each of the file blocks until the entire resource file or image file is assembled in the nonvolatile memory of the phone.

In another aspect, a system for downloading or uploading files to or from a mobile phone includes a mobile phone and a computer. The system further includes a means for downloading or uploading, via at least one AT command, a resource file into a nonvolatile memory of the phone, or an image file into a memory segment of the computer, respectively.

In another aspect, the means for downloading or uploading includes a GSM terminal adapter.

Other features and advantages of the invention will appear hereinafter. The features of the invention described above can be used separately or together, or in various combinations of one or more of them. The invention resides as well in sub-combinations of the features described.

### BRIEF DESCRIPTION OF THE DRAWINGS

FIG. 1 is a schematic diagram of a mobile phone connected to a computer via a terminal adapter.

FIG. 2 is a flow diagram of a method for downloading or uploading a resource file, image file, or other file to or from a mobile phone.

### DETAILED DESCRIPTION OF THE DRAWINGS

The methods and features described herein may be implemented in any mobile telephone, such as a cellular phone, or in any other telephone that includes a processor and memory storage, such as nonvolatile flash memory. Flash memory is a type of electrically erasable programmable read-only memory (EEPROM), in which a section of memory cells can typically be erased in a single action, or in a “flash.” Flash memory can be written in blocks, rather than bytes, which makes it relatively easy to update.

A key feature of flash memory is that it retains its data when the device in which it is contained is powered off. Additionally, a flash memory chip, for example, can be electrically erased and reprogrammed without being removed from the circuit board on which it resides. In the mobile phones described herein, nonvolatile memory is preferably embodied in a flash memory card or chip that is insertable into a mobile phone. The nonvolatile memory may alternatively be provided in the phone in or on any other suitable medium.

Information stored in the mobile phones described herein is preferably retrievable and/or modifiable via AT (Attention) commands. AT commands are generally used by phone designers or programmers to add to, retrieve from, and/or manage data and settings in a mobile phone. An existing AT command set is outlined and described in ETSI (European Telecommunications Standards Institute) GSM (Global System for Mobile Communications) 07.07.

ETSI GSM 07.07 defines several AT commands for adding, retrieving, and managing data and phone settings. AT+CGMI, for example, is the GSM 07.07 AT command for displaying a manufacturer ID number of a mobile device, such as a mobile phone. For the systems and methods described herein, an extended set of AT commands, which are directed to managing resource files, image files, and/or other suitable files and phone directories, is defined, as further described below. The extended set of AT commands is complementary to the GSM 07.07 AT commands.

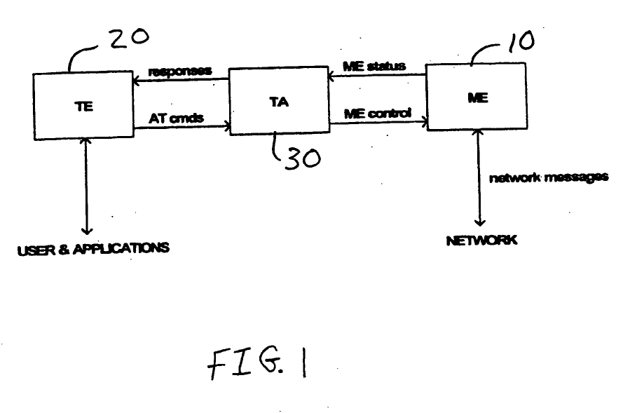

As shown in FIG. 1, an exemplary mobile phone 10, or other suitable mobile equipment (ME), is preferably connectable to a computer 20, or other suitable terminal equipment (TE), via a terminal adapter (TA) 30, such as a GSM data card or other GSM module. FIG. 1 illustrates is a typical system setup for adding, retrieving, and/or managing information stored in a mobile phone using AT commands. Other suitable system setups may be utilized, however. The computer 20 is preferably connectable to the terminal adapter 30 via a serial cable, an infrared link, and/or another suitable linking device. The mobile phone 10 is preferably connectable to the terminal adapter 30 via a USB cable, or another suitable serial cable, and/or any other suitable linking device.

In the example above, when a user enters the AT command, AT+CGMI, at the computer 20, the AT command is sent to the terminal adapter 30. The terminal adapter 30 interprets the AT command and routes it to the mobile phone 10 in a format that the phone's processor can interpret. The mobile phone 10 then sends data indicating the requested phone status (which may be retrieved from the phone's memory or from a network in communication with the phone), in this case, the manufacturer ID number of the phone 10, to the terminal adapter 30. The terminal adapter 30 interprets the data and sends a computer-readable response to the computer 20, which preferably displays the manufacturer ID number in a user-readable format on the computer's display device.

The commands of the extended AT command set for managing resource files, image files, and/or other suitable files and directories are preferably executable in the same or a similar manner as that just described. The extended AT command set preferably includes file management commands, directory management commands, and/or any other suitable commands. A file management AT command may be, for example, AT+MGF, while a directory management AT command may be, for example, AT+MGD. Any other combination of identifier letters may alternatively be used to define the commands in the extended AT command set. The AT commands are typically followed by specific file or directory information, as further described below.

An exemplary format for a file management AT command line is as follows:
AT+MGF=<mode>, [<block_num>, <block_length>, <total_num>“<file name>”,“<new file name>”]

where the “mode” is preferably an integer corresponding to one or more of the following file functions: (1) upload file; (2) read file size; (3) delete file; (4) add file; (5) replace file; (6) rename file; and/or any other suitable file management functions. “<block_num>” is preferably an integer (e.g., between 0 and 60,000) corresponding to the identification number of a file being downloaded or uploaded. “<block_length>” is preferably an integer (e.g., between 1 and 500) corresponding to the length of data being downloaded or uploaded. “<total_num>” is preferably an integer corresponding to the total number of data blocks being uploaded or downloaded. “<file name>” is preferably a data string representing the name of a file being manipulated, including the absolute path to the file. “<new file name>” is preferably a data string representing the name of a file being modified, including the absolute path to the file.

An exemplary format for a directory management AT command line is as follows:
AT+MGD=<mode>,“<directory name >”, [“<new dir name>”]

where the “mode” is preferably an integer corresponding to one or more of the following directory functions: (1) directory inquiry; (2) add directory; (3) delete directory; (4) rename directory; and/or any other suitable directory functions. “<dir name>” is preferably a data string representing the name of a directory being manipulated, including the absolute path to the directory. “<new dir name>” is preferably a data string representing the name of a directory being modified, including the absolute path to the directory.

The extended AT commands may be entered directly into the computer 20, via a keyboard or other suitable input device, to initiate the desired functions. Alternatively, the extended AT commands may be implemented or embodied in a software program, or other management program, that may be downloaded into a memory segment of the computer 20. For example, the AT commands may be embodied in a software program, which may include a graphical user interface (“GUI”), a menu interface, and/or another suitable user interface, for allowing a user to select the desired function(s) to be performed via the AT commands. The user preferably makes the selections via a keyboard, a mouse, or another suitable input device. Upon selection of a function by the user, the software program executes the function via the AT commands embodied in the software program.

The mobile phone 10 may additionally, or alternatively, include a menu interface or other suitable interface for allowing a user to initiate certain AT command functions from the mobile phone 10 itself. For example, the mobile phone 10 may include a menu item that allows a user to upload an image file from the phone 10 to a memory segment of the computer 20 via the terminal adapter 30. Alternatively, the user may enter an AT command at the computer 20 requesting that the image file be uploaded into the database in the computer 20.

At initial startup, the mobile phone 10 may include one or more pre-programmed resource files, stored in the nonvolatile, or flash, memory of the mobile phone 10, including ring tone files, font files, background “wallpaper” files, and/or any other files related to the sounds and visual effects produced by the phone 10. Default resource files are preferably enabled in the mobile phone 10 at initial startup. Alternatively, a user may be required to select which resource files to enable at the phone's initial startup.

The mobile phone 10 may include, for example, one or more user-selectable ring tones, such as a conventional ring sound, a classical music theme, etc., stored in the phone's flash memory at initial startup. The mobile phone 10 may also include a collection of user-selectable fonts, stored in the flash memory of the phone 10, in which characters, such as letters and numbers, can be displayed on the phone's display screen, and/or sent as text messages. Additionally, various wallpaper or screensaver images may be stored in the flash memory of the mobile phone 10 for selection by the user. Other aural tones, visual images, and/or other suitable resource files may also be stored in the flash memory of the phone 10.

A compiler in the mobile phone preferably compiles the resource files, image files, and/or other files into one or more designated segments of the flash memory. The compiler also preferably generates MAP files indicating the location, number, and/or size of the files stored in the memory segments. For example, the compiler may generate a MAP file indicating that a first 10-bit ring tone file is stored in a first location of a first segment of the flash memory, and that a second 12-bit ring tone file is stored in a second location of the first segment of the flash memory.

Resource files to be downloaded into the mobile phone's flash memory may be obtained from any suitable location. For example, a resource file management program, including a database containing a variety of user-selectable resource files, may be stored in the computer 20. Resource files may then be downloaded from the database in the resource file management program, into the phone's flash memory, via the extended set of AT commands.

Additionally or alternatively, resource files may be downloaded to the computer 20 from web sites resident on the Internet, or from a suitable network location. In such cases, resource files may be downloaded from their resident locations and saved in a database in the resource file management program, and/or the resource files may be downloaded directly to another location in the computer's memory.

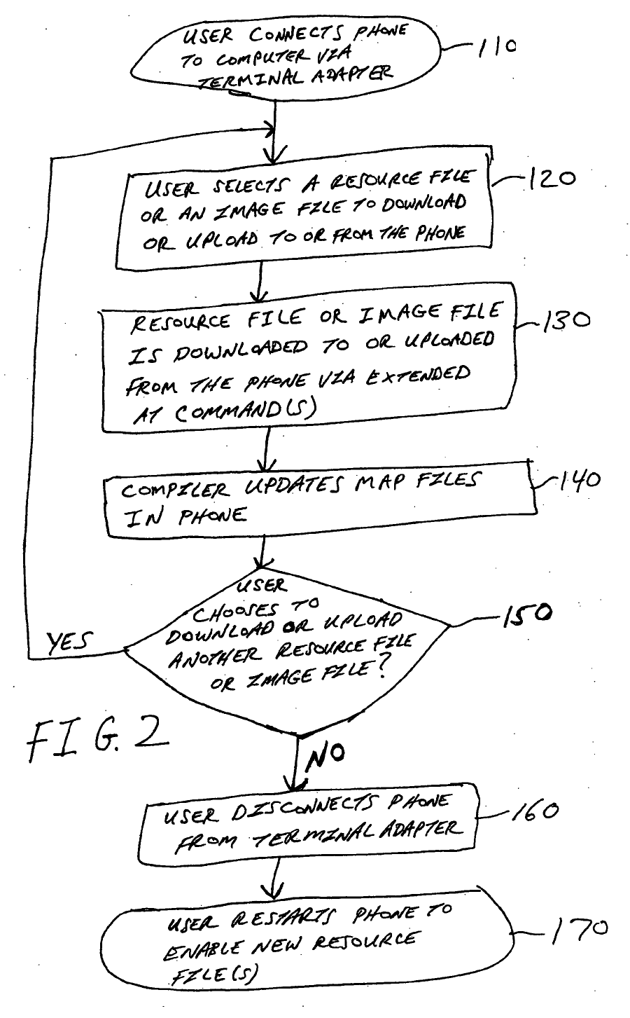

FIG. 2 is a flow diagram illustrating one preferred method for downloading or uploading one or more resource files, image files, and/or any other suitable files to or from a mobile phone using the extended AT commands described herein. At step 110, a user connects the mobile phone 10 to the computer 20 via the terminal adapter 30, as shown in FIG. 1. The user, via an input device connected to or otherwise in communication with the computer, selects a resource file to download from the computer 20 to the phone's flash memory, or an image file to upload from the mobile phone 10 to a memory segment of the computer 20, as shown at step 120. In one embodiment, as described above, the user may alternatively select to upload an image file from the mobile phone 10 to the computer 20 via a menu in the phone 10.

The user may input AT commands directly for downloading or uploading the selected file, or the AT commands may be embodied in, and executable via, a software program, as described above. In most cases, the AT commands are executable via a software program, since typical users do not have experience entering AT commands directly into a computer 20.

In one preferred embodiment, the user is able to “drag and drop,” via a GUI, a selected resource file or image file between the computer 20 and the mobile phone 10. Alternatively, the user may transfer a resource file or image file via an on-screen menu, and/or via any other suitable user interface. If the user is a designer or a programmer, or someone who otherwise has knowledge of how to properly input AT commands, the user may enter the AT commands directly to manage the resource files, image files, and/or other files.

Once a resource file or image file is selected by the user, the file is downloaded or uploaded to or from the phone, via one or more of the extended AT commands, as shown at step 130. For example, using the extended AT command set outlined above, if the user chooses to upload an image file from the mobile phone 10 to the computer 20, an AT command for reading the file size, e.g., AT+MGF(<mode>=2>), is first entered by the user, or executed via a software program. An AT command for uploading the image file, e.g., AT+MGF(<mode>=1>), is then entered by the user, or executed via a software program, to upload the image file to a memory segment in the computer 20.

The uploading command may have to be executed successively if the image file includes more than one file block, i.e., if the image file size is greater than the maximum block length that can be uploaded at one time. In such a case, the image file is progressively assembled into a full image as the file blocks are uploaded to the computer 20.

If the user chooses to replace, for example, a resource file in the flash memory of the mobile phone, an AT command for replacing a resource file, e.g., AT+MGF(<mode>=5>) (from the extended AT command set outlined above), is entered by the user, or executed via a software program. When the “replace file” function is chosen, the resource file to be replaced is disabled and/or deleted or otherwise removed from the phone's flash memory. The selected resource file is then downloaded into the phone's flash memory.

Similar to the uploading process, the downloading process may have to be executed successively if the resource file includes more than one file block, i.e., if the resource file size is greater than the maximum block length that can be downloaded at one time. In such a case, the resource file is progressively assembled into a full image as the file blocks are downloaded to the mobile phone 10. Similar steps may be performed to execute the other file management commands, and the directory management commands, outlined above, as well as any other suitable commands.

Once the image file or resource file is uploaded or downloaded, the mobile phone's compiler preferably updates the MAP files in the phone 10, indicating the location and/or size of the resource files, image files, and/or other files stored in the phone's flash memory, as shown at step 140. The user then chooses whether to download and/or upload another resource file or image file to or from the mobile phone 10, as shown at step 150. If the user chooses to do so, the process returns to step 120, where the user selects another resource file or image file to download or upload.

If the user chooses not to download or upload another resource file or image file, the user may then disconnect the mobile phone 10 from the terminal adapter 30, as shown at step 160. The user may also disconnect the terminal adapter 30 from the computer 20. The user then preferably restarts the mobile phone 10 to enable any new resource files downloaded into the phone's flash memory, as shown at step 170.

While embodiments and applications of the present invention have been shown and described, it will be apparent to one skilled in the art that other modifications are possible without departing from the inventive concepts herein. Importantly, many of the steps detailed above may be performed in a different order than that which is described. For example, in practice, the compiler may update the MAP files in the mobile phone 10 (step 140 in FIG. 2) after the user chooses not to download or upload any additional resource files or image files (step 150 in FIG. 2). The invention, therefore, is not to be restricted except by the following claims and their equivalents.

What is claimed is:

1. A method for downloading a resource file to a phone, comprising the steps of:
defining a set of AT commands for managing resource files;
connecting the phone to a computer;
reading, via at least one of the AT commands, a first resource file stored in the computer; and
downloading, via at least one of the AT commands, the first resource file into a nonvolatile memory of the phone.

2. The method of claim 1 wherein the downloading step is performed without removing an existing second resource file from the nonvolatile memory of the phone.

3. The method of claim 1 further comprising the step of removing an existing second resource file from the nonvolatile memory of the phone before performing the downloading step.

4. The method of claim 1 wherein the AT commands are executable via a software program in which the AT commands are embodied.

5. The method of claim 1 wherein the phone is connected to the computer via a GSM terminal adapter.

6. The method of claim 1 wherein the resource file comprises a plurality of file blocks, and wherein the downloading step is successively performed for each of the file blocks until the entire resource file is assembled in the nonvolatile memory of the phone.

7. The method of claim 1 further comprising the step of restarting the phone, after the downloading step, to enable the first resource file in the phone.

8. The method of claim 1 wherein the first resource file comprises one of a ring tone file, a wallpaper file, and a font file.

9. The method of claim 1 further comprising the step of updating a MAP file in the phone, indicating at least one of a size and a location of the first resource file, after the downloading step.

10. The method of claim 1 further comprising the step of uploading, via at least one of the AT commands, an image file from the phone into a memory segment of the computer.

11. A method for downloading or uploading files to or from a mobile phone, comprising the steps of:
defining a set of AT commands for managing the files;
connecting the phone to a computer;
reading, via at least one of the AT commands, at least one of a resource file stored in the computer, and an image file stored in the phone; and
downloading or uploading, via at least one of the AT commands, the resource file into a nonvolatile memory of the phone, or the image file into a memory segment of the computer, respectively.

12. The method of claim 11 wherein the AT commands are executable via a software program in which the AT commands are embodied.

13. The method of claim 11 wherein the phone is connected to the computer via a GSM terminal adapter.

14. The method of claim 11 wherein the resource file or image file comprises a plurality of file blocks, and wherein the downloading or uploading step is successively performed for each of the file blocks until the entire resource file or image file is assembled in the nonvolatile memory of the phone.

15. A system for downloading or uploading files to or from a mobile phone, comprising:
a mobile phone;
a computer; and means for downloading or uploading, via at least one AT command, a resource file from the computer into a nonvolatile memory of the phone, or an image file from the phone into a memory segment of the computer, respectively.

16. The system of claim 15 wherein the at least one AT command is executable via a software program in which the at least one AT command is embodied.

17. The system of claim 15 wherein the means for downloading or uploading comprises a GSM terminal adapter.

18. The system of claim 15 wherein the phone includes means for compiling resource files into the nonvolatile memory of the phone.

19. The system of claim 18 wherein the means for compiling includes a means for updating MAP files in the phone that indicate at least one of a size and a location of each the resource files.

20. The system of claim 15 wherein the resource file comprises one of a ring tone file, a wallpaper file, and a font file.
